(19) United States
(12) Patent Application Publication
(10) Pub. No.: US 2015/0267441 A1
(43) Pub. Date: Sep. 24, 2015

(54) MOTOR VEHICLE LOCK WITH POSITION DETECTION MEANS

(71) Applicant: KIEKERT AKTIENGESELLSCHAFT, Heiligenhaus (DE)

(72) Inventors: Carsten Fuchs, Dusseldorf (DE); Christian Barmscheidt, Duisburg (DE)

(21) Appl. No.: 14/437,061

(22) PCT Filed: Sep. 27, 2013
(86) PCT No.: PCT/DE2013/000552

§ 371 Date: Apr. 20, 2015

(30) Foreign Application Priority Data
Oct. 24, 2012 (DE) 10 2012 020 845.6

(51) Int. Cl. E05B 85/24; E05B 81/66

(52) U.S. Cl. CPC E05B 85/243; E05B 81/66

(57) ABSTRACT

The invention relates to a lock for a motor vehicle, comprising a locking mechanism that includes a rotary catch and a pawl and position detection means. The aim of the invention is to further develop a lock of said type. Said aim can be achieved in that the locking mechanism of the claimed lock comprises position detection means which can be actuated by a lever which can influence the position of a pawl. As said lever is generally arranged particularly close to a housing wall for the lock, electrical conductor tracks of the position detection means are reduced. Alternatively or supplementary, position detection means are arranged outside of a rotary plane of the rotary latch and/or the pawl which can be actuated by the position detection. Normally, a space is provided outside of the respective rotary plane. Said space is therefore used in addition.

### CROSS-REFERENCE TO RELATED APPLICATIONS

This application is the U.S. national stage application of International Patent Application No. PCT/DE2013/000552, filed Sep. 27, 2013, which claims priority of German Application No. 10 2012 020 845.6, filed Oct. 24, 2012, which are both hereby incorporated by reference.

### BACKGROUND

The invention relates to a lock for a motor vehicle comprising a locking mechanism that includes a rotary latch and a pawl with which the rotary latch can be locked in a closed position.

As disclosed in printed matter DE 10 2009 026 921 A1, the rotary latch of a motor vehicle lock contains a fork-shaped inlet slot, also referred to as inlet opening, in which a locking bolt or also referred to as lock holder of a motor vehicle door or motor vehicle flap engages, when the motor vehicle door or motor vehicle flap is being closed. In this case, the locking bolt turns the rotary latch from an open to a closed position. Once the rotary latch has reached a closed position, the locking bolt can no longer leave the inlet slot of the rotary latch. In such a closed position, a pawl latches the rotary latch, so that it can no longer be turned back into the open position.

DE 10 2009 026 921 A1 also discloses that a lock for a motor vehicle is provided with two detent positions that can be assumed in succession during the closing of the rotary latch, the so-called preliminary and main latching position. In the main latching position the rotary latch is retained by the main latching pawl.

In order to ensure that a pawl is not inadvertently moved out of its latching position, DE 10 2009 026 921 A1 provides a blocking lever, blocking such a movement when the rotary latch is latched. Such a blocking lever is required for the main latching pawl if the rotary latch and the main latching pawl are designed in such away that the pawl in the main latching position introduces an opening moment into the rotary latch, in order to be able to release a locking mechanism with a minimum of force.

DE 10 2009 026 921 A1 furthermore discloses the use of micro switches arranged at the sides of the pawls which can be operated by lateral contour sections of the preliminary latching pawl and/or main latching pawl. The position of the respective pawl can be determined by activating the micro switch in order to control a closing aid with the aid of which the locking mechanism is automatically moved from the preliminary into the main latching position.

DE 10 2008 035 607 A1 discloses the provision of micro switches for detecting the position of the locking mechanism, in order to, for instance, control interior lighting in a motor vehicle. The micro switches are arranged on the side of two pawls and can again be confirmed by lateral contours of the pawls in order to determine the positions of the locking mechanism in this manner.

### SUMMARY

Unless stated otherwise below, the above characteristics can be combined individually or in any combination with the object of the invention.

It is the task of the invention of further developing a lock of the described design.

The task of the invention is solved by a lock with the characteristics of the first claim. Advantageous embodiments are described in the sub claims.

In order to solve the task, the locking mechanism of the lock of the invention contains a position detection means that can be actuated by a lever able to influence the position of a pawl. The lever influences the position of a pawl when it directly or indirectly pivots the pawl or directly or indirectly blocks the pivoting of the pawl.

In contrast to the aforementioned prior art, the position of a pawl is not directly but indirectly determined by checking the position of a lever, able to influence the position of the pawl. As this lever is generally installed particularly close to the housing walls for the lock, electric strip conductors of the position detection means can therefore be reduced. Production and material costs can consequently be reduced significantly.

Alternatively or in addition, a position detection means can be arranged outside of a rotary plane of the rotary latch and/or the pawl which can be actuated by the position detection means. Rotary plane refers to the lane, in which the respective component, i.e. the pawl or the rotary latch can be pivoted or turned. Also this arrangement of a position detection means has proven to be particularly advantageous. Generally installation space is available outside of the respective rotary plane. This installation space is thus now being utilized. Overall, this embodiment allows for a particularly compact design. Generally, strip conductors for the position detection means can also be installed particularly advantageously for the electric connection of the lock. Only very short strip conductors are required.

In one embodiment of the invention, the two position detection means are outside of the rotary plane within which the rotary latch and/or main latching pawl can be pivoted. In particular all position detection means are located outside of the rotary plane, within which the rotary latch and/or main latching pawl can be pivoted. The base surface required for a locking mechanism can thus be advantageously kept to a minimum. This design regularly also uses a plane outside of the rotary plane, in which the rotary latch and the main latching pawl can pivot. The available installation area can thus be fully utilized. Additional usage occurs, in particular, where installation place has, for instance, to be provided for a preliminary latching pawl outside of the main latching pawl.

The lever able to influence the position of a pawl of the locking mechanism is, in particularly essentially located in the rotary plane, in which the rotary latch can be pivoted. Such a lever advantageously contains several protruding pins or elevations, able to activate or pivot components outside of this plane and, in particular a preliminary latching pawl and/or a position detection means. The lever can also generally influence the position of a pawl located in the same rotary plane as this lever

In order for the main latching pawl to activate a push switch acting as a position detection means it advantageously contains a step-like surface in one area and, in particular, in an end area of a lever arm.

The lever that can at least influence one position of a pawl, is preferably a triggering lever that can be pivoted in order for the locking mechanism to engage. Such a triggering lever has therefore a double use. A triggering lever is generally pivoted as a result of an actuation of a handle connected thereto and in order to latch the locking mechanism.

The triggering lever can, in particular, pivot a preliminary latching pawl and/or a blocking lever in order to release the locking mechanism.

The position detection means is, in particular, a push switch and particularly advantageously a micro switch. This embodiment offers a particularly simple and reliable position detection means. The position detection means can, however, also for example be an optical sensor or a capacitive sensor.

In one embodiment of the invention, the locking mechanism contains a preliminary latching pawl, arranged outside of the rotary plane of the main latching pawl. The rotary latch than includes, in particular a stop in form of an elevation or a pin, protruding from the rotary plane of the rotary latch in order for the preliminary latching pawl to engage the rotary latch.

In one embodiment of the invention, the rotary latch can introduce an opening moment in the main latching pawl when in the main latching position. This embodiment contains a blocking lever, able to block such an unintended release of the pawl.

In one embodiment, the entire electronics for the lock are arranged on one side, reducing production cost. There are thus two physically separated areas containing electric or electronic components and that have to be bridged by strip conductors.

In one embodiment, one or several and, preferably, all position detection means are arranged above the inlet opening of the rotary latch in the installed state of the locking mechanism. In this arrangement, the position detection means and the electrical and electronic equipment, also located in this area, are particularly reliably protected against dirt, which can enter the locking mechanism through the inlet opening which is otherwise protected, in particular, by the housing. For the same reasons, this also offers better protection for the electrical and electronic equipment as regards moisture. The locking mechanism is installed when it is assembled in a door or a flap of, in particular, a motor vehicle.

Advantageously, the lock contains a maximum of two position detection means. A maximum of two position detection means suffice in order to be able to detect all positions of the locking mechanism.

The invention furthermore advantageously contributes to reducing the number of housings to be provided in order to be able to produce different types of locks with compact housings. As a result, the manufacturing cost for producing different locks can be reduced.

### BRIEF DESCRIPTION OF THE DRAWING

FIG. 1 shows details of the locking mechanism with precicesly two position detection means.

### DETAILED DESCRIPTION OF THE DRAWING

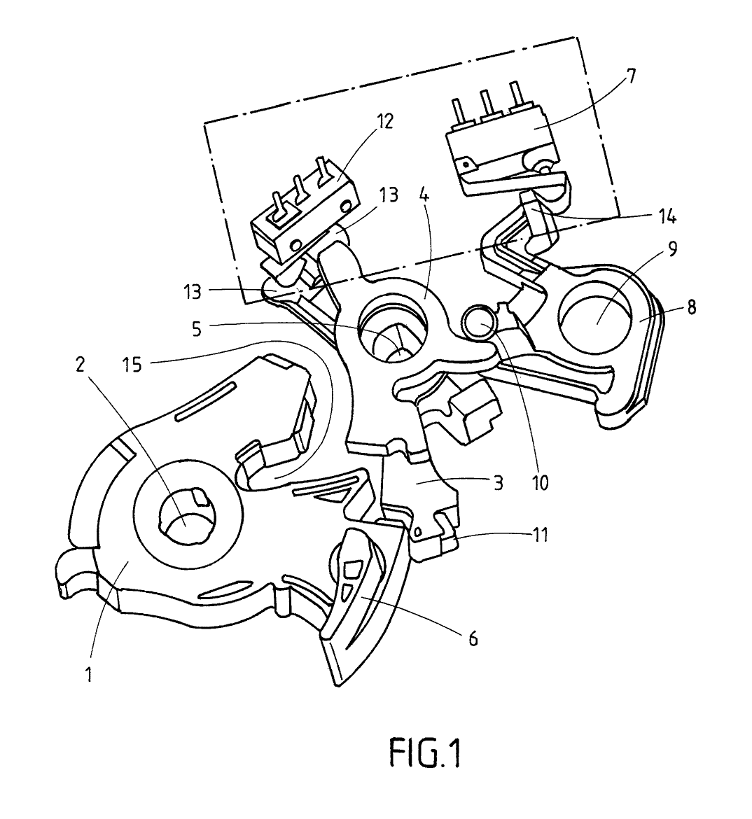

FIG. 1 shows a locking mechanism with a rotary latch 1 that can be pivoted around an axis area 2. The locking mechanism contains a main latching pawl 3 and a preliminary latching position 4 that can be pivoted around a common axis area 5. The rotary latch 1 is locked by the main latching pawl 3. The locking mechanism is therefore in the main latching position. The preliminary latching pawl 4 is arranged above and thus outside of the rotary plane of the main latching position 3 and rotary latch 1. An elevation 6 extends upwards from the rotary latch 1 for latching in the preliminary latching position.

The locking mechanism includes a first push switch 7 as a position detection means that can be actuated by the triggering lever 8. The triggering lever 8 can be rotated or pivoted around its axis area 9. By means of an upwards protruding pin 10, the triggering lever 8 can directly pivot the preliminary latching pawl 4 and can also prevent pivoting of the preliminary latching pawl 4 in the opposite direction. The triggering lever 8 can furthermore pivot a blocking lever—not shown in the figure. The blocking lever can block the main latching position 3 when it is in its detent position. When the blocking lever blocks the main latching pawl 3, a blocking surface of the blocking lever rests against the blocking surface 11 of the main latching pawl 3. The triggering lever can therefore directly influence the position of the main latching pawl.

In addition, a push switch 12 is arranged above and thus outside of the rotary plane of the rotary latch 1 and main latching pawl 3. The main latching pawl 3 can actuate the push switch 12 by a step-like surface 13 arranged at an end of a lever arm.

Both position detection means 7 and 12 are located above and thus outside of the rotary plane, within which the rotary latch 1, the main latching pawl 3 and the triggering lever 8 can be pivoted. Generally, the blocking lever is pivoted in the same plane as said three components, rotary latch, main latching pawl 3 and triggering lever 8. The triggering lever 8 contains a pin 14 projecting upwards, with which the push button 7 can be actuated. The two push buttons 7 and 12 are at least substantially located in the rotary plane of the preliminary latching pawl 4. The inlet opening of the rotary latch 1 is indicated by reference numeral 15.

### LIST OF REFERENCE NUMERALS

1: Rotary latch
2: Axis area for rotary latch
3: Main latching pawl
4. Preliminary latching pawl
5: Axis area for preliminary latching pawl and for main latching pawl
6: Elevations of rotary latch
7. Push button
8: Triggering lever
9: Axis area for triggering lever
10: Pin projecting from triggering lever
11: Blocking surface
12. Push button
13. Step-shaped surface
14. Pin projecting from triggering lever
15: Inlet opening of rotary latch

1. Lock for a motor vehicle comprising a locking mechanism that includes a rotary latch (1) and pawl for latching the rotary latch, characterized in that a position detection means is provided, that can be actuated by a lever which can influence the position of a pawl and/or that a position detection means is arranged outside of the rotary plane of the rotary latch and/or of the pawl, that can actuate the position detection means.

2. Lock according to claim 1, characterized in that two position detection means are arranged outside of the rotary plane of the rotary latch and/or outside of the rotary plane of a main latching pawl of the locking mechanism.

3. Lock according to claim 2, characterized in that the position detection means is/are located in the rotary plane of a position detection means of the locking mechanism.

4. Lock according to claim 3, characterized in that the lever, able to influence the position of the pawl, is arranged inside the rotary plane of the rotary latch and/or of the main latching pawl.

5. Lock according to claim 4, characterized by at least one protruding pin or protruding area, for actuating a position detection means and/or a pawl.

6. Lock according to claim 5, characterized in that one pawl contains a step-shaped surface for actuating a position detection means.

7. Lock according to claim 6, characterized in that the lever, able to influence the position of a pawl is a triggering lever for disengaging the locking mechanisms.

8. Lock according to claim 7, characterized in that the entire electronics of the lock is only arranged in one place.

9. Lock according to claim 8, characterized in that one or preferably all position detection means are arranged above the inlet opening of the pawl in the installed state of the locking mechanism.

10. Lock according to claim 9, characterized in that a push button is provided as position detection means.

11. Lock according to claim 1, characterized in that the position detection means is located in the rotary plane of a position detection means of the locking mechanism.

12. Lock according to claim 11, characterized in that the lever, able to influence the position of the pawl, is arranged inside the rotary plane of the rotary latch and of the main latching pawl.

13. Lock according to claim 12, characterized by at least one protruding pin or protruding area for actuating a position detection means.

14. Lock according to claim 13, characterized in that one pawl contains a step-shaped surface for actuating a position detection means.

15. Lock according to claim 14, characterized in that the lever can influence the position of a pawl is a triggering lever for disengaging the locking mechanisms.

16. Lock according to claim 15, characterized in that the entire electronics of the lock is only arranged in one place.

17. Lock according to claim 16, characterized in that the position detection means is arranged above the inlet opening of the pawl in the installed state of the locking mechanism.

18. Lock according to claim 17, characterized in that a push button is provided as position detection means.

19. Lock for a motor vehicle comprising a locking mechanism that includes a rotary latch and pawl for latching the rotary latch, characterized in that a position detection means is provided that can be actuated by a lever which can influence the position of a pawl, wherein the position detection means is arranged outside of the rotary plane of the rotary latch that can actuate the position detection means.

20. Lock for a motor vehicle comprising a locking mechanism that includes a rotary latch and pawl for latching the rotary latch, characterized in that a position detection means is provided that can be actuated by a lever which can influence the position of a pawl, wherein the position detection means is arranged outside of the rotary plane of the pawl that can actuate the position detection means.
